(19) United States
(12) Patent Application Publication
(10) Pub. No.: US 2004/0104288 A1
(43) Pub. Date: Jun. 3, 2004

(54) Portable device for the safe and effective grinding, containment and disposal of burned-out fluorescent lamps

(76) Inventor: Willy Dacanay, Las Vegas, NV (US)

Correspondence Address: WILLY DACANAY, 9865 RAVEN WING CT., LAS VEGAS, NV, 89123, US

(21) Appl. No.: 10/307,540

(22) Filed: Nov. 29, 2002

(51) Int. Cl. B02C 19/12

(52) U.S. Cl. 241/99

(57) ABSTRACT

A portable device for effectively grinding, crushing and containing burned out fluorescent lamps within a leak-proof two-component safety closure system, comprising a combination of a mounted electric motor-activated hi-speed rotating grinding and crushing means, an internally feeding guide tube means, a strong non-porous containment means, a see-through transparent leak-proof window with cleaning means, and at least a pair of locking and unlocking means, a descent limiting means, and a foot-controllable outwardly extending structural means to help in the easy disengagement of said two-component safety closure system to facilitate the mounting and removal of the said containment means; altogether functioning as an environment-and-user-friendly prevention or minimization of the hazards of spreading the dangerous debris and poisonous contents of burned out fluorescent lamps.

### BACKGROUND OF THE INVENTION

1. Field of Invention

This invention relates generally to the disposal of burned out fluorescent lamps, and more specifically to a portable device and method to achieve a safe and effective user-and-environment friendly grinding, containment and disposal of burned out fluorescent lamps.

2. Background of the Invention

Ordinarily, burned out fluorescent lamps are disposed of unsafely by a great number of people in many parts of the world. Usually, they handle each one of them individually by hand or in groups put together and wrapped in open sacs, then they place them into some form of garbage containers with other garbage materials, which are then altogether collected by garbage collectors and dumped into garbage dumping sites in various locations of numerously different respective communities. This common practice, however is not safe for the handlers of these burned-out fluorescent lamps. Neither is this practice environment-friendly, because of its predisposing hazards of unsafely spreading the poisonous gaseous contents of these disposed burned-out fluorescent lamps.

To date, there still is not even any single known device that is specifically designed to be used for safely handling, grinding, crushing and containing burned out fluorescent lamps which can effectively prevent or minimize the risks of spreading the poisonous gaseous materials that are hazardous to the environment and to those handling them.

### OBJECTS AND ADVANTAGES

Deeply concerned about the above-mentioned risks and hazards posed to the handlers as well as to the environment, the inventor has dedicated himself in pursuit of developing the present invention, in order to be of true positive value not only to his community, but also to the world-at-large, believing to the best of his ability that the originality and superiority of his invention can effectively solve the aforesaid problems.

In accordance to the above-mentioned general intention of the inventor regarding the uses and advantages of his present invention, he enumerates the more specific and expanded objects and superiority of his said present invention as follows:

1) One object of the present invention is to provide a portable electric motor-activated device and method to be able to effectively grind and crush the succeeding segments of each individually fed burned-out fluorescent lamp as it is inserted internally into its two-component safety closure system, and then collected within its containment means without the dangers of spreading the debris and poisonous gaseous materials of each grinded or crushed burned-out fluorescent lamps.

2) Another object of the present invention is to provide the said two-component safety closure system, comprising of (a)—the upper closure component, and (b) the lower closure component.

3) Still a further object of the present invention is to provide a centrally-located electric motor attached rigidly and in a stable manner, and penetrating there-through the rigid and firm roof of the said upper closure component.

4) A yet further object of the present invention is to provide a rigid downwardly extending structure connecting from the lower portion of the attached electric motor.

5) Another further object of the present invention is to provide a firm attachment means at the lowermost portion of the said rigid downwardly extending structure into which at least a pair of equal-length chains are strongly anchored, so that when the electric switch is turned “ON” to activate the said electric motor, the said equal-length chains are allowed to swing rapidly outwards so as to act as a hi-speed grinder.

6) A still further object of the present invention is to provide an off-centered guide tube that is firmly attached to and through the roof of the said upper closure component, and which, in the closed position, capable of safely providing an optimal leak-proof downwardly directing internal guide of uniform cylindrical diameter so to allow the easy and gradual downward internal feeding for each individual burned-out fluorescent lamp being inserted at a right angle position relative to the horizontal plane of the said rigid roof of the said upper closure component; said guide tube's lowermost end being optimally positioned higher than the highest upward angle of swing of the said pair of equal-length chains in order that it cannot be impacted by the said pair of swinging equal-length chains, yet, only allowing the lowermost segments of the downwardly fed or perpendicularly inserted burned-out fluorescent lamp to be hit and impacted and grinded and crushed by the swinging pair of equal-length chains swinging at hi-speed.

7) A yet further object of the present invention is to provide a transparent see-through means located at an area within the said rigid roof of the said upper closure component; said see-through means being leak-proof and for the purpose of checking the progress or status of the grinding and crushing of the inserted burned-out fluorescent lamp or lamps as the resultant debris and poisonous gaseous materials released from the grinded and crushed burned out fluorescent lamp or lamps are collected within the said two-component safety closure system; said see-through means also being provided with a potent rotatable visual cleaning means to effect the maintenance of transparent clarity of the said see-through means without the necessity of disengaging the said upper closure component from its sealing engagement with the said lower closure component.

8) A still further object of the present invention is to provide an effective easily operable attachment means to optimally coordinate the said upper closure component with the said lower closure component so as to effect a leak-proof containment of the debris and the released poisonous gaseous materials of the grinded and crushed burned-out fluorescent lamp or lamps contained within said two-component safety closure system during functional operations.

9) A yet still further object of the present invention is to provide an optimal lower closure component that can easily accommodate a disposable plastic or paper containment means for collecting the debris and released poisonous gaseous materials of the grinded and crushed burned-out fluorescent lamps without leakage and external penetration of the said debris and the released poisonous materials through the said disposable plastic or paper containment means during the collection and grinding or crushing phase operations of the device.

10) Another still further object of the present invention is to provide a flat structural extension means attached there-around the base of the said lower-closure component, and which extends outwardly so as to afford some sort of foot-controllable means to help in the easy disengagement of the said upper closure containment from the said lower closure component.

11) A yet another object of the present invention is to provide a valve means at the upper internal portion of the said guide tube that is in order to prevent the potential leakage of the liberated poisonous gaseous materials of the burned-out fluorescent lamps through the said guide tube during the grinding, crushing and containment functions of the said device.

12) A still further object of the present invention is to provide structural side guide means, attached rigidly to the said roof of the said upper closure component, in direct reachable proximity and in an optimal functional alignment to the said guide tube, in order to control the descent of the being burned out fluorescent lamp within the optimal range of crushing and grinding operations of the said device.

### SUMMARY OF INVENTION

In accordance with the objects and advantages of the present invention as aforementioned, the present invention comprises of the following components and combinations of items:

a) an upper closure component, having an electric motor attached thereto, and having a guide tube means capable of accommodating and guiding the inserted burned out fluorescent lamp interiorly into it, and having impacting and grinding and crushing means to turn said burned out fluorescent lamp into debris, and including limiting means of controlling the internal insertion of said burned out fluorescent lamp; said electric motor having structural connection to said impacting and grinding and crushing means, and including a transparent see-through means and cleaning means to allow easy check up from the outside pertaining to the interior containment as well as the impacting and grinding and crushing progress or status of said device, and including locking and unlocking means—all of which are coordinating and engaging in functionality with:

b) a lower closure component, having optimal and correspondingly shaped containment space to accommodate a substantially large enough non-porous strong plastic or paper sac-conforming containment material placed there-between the internal wall of said lower closure component, and the external wall of the correspondingly and optimally shaped major lower portion of said upper closure component while in the operational engaged containment and impacting and grinding and crushing phase of said device; said lower closure component equipped with a structural means attached there-around its base as an easy foot-controllable detaching means to facilitate the disengagement of said upper closure component from the said lower closure component; said lower closure component having a corresponding locking means to engage in a coordinating manner with the said locking counterpart attached to the said upper closure component.

Other further objects and advantages of the present invention will become apparent during the detailed explanations of its preferred embodiments, mostly with reference to the figure drawings set forth in the patent specifications.

### BRIEF DESCRIPTIONS OF THE DRAWINGS

FIG. 1 is a perspective side elevational view, favoring the top view, inclusive of a part cut-away view of the said upper closure component of the said two-component safety closure system of one preferred embodiment of the present invention, and showing the corresponding structural elements as attached thereto.

FIG. 2 is a perspective side elevational view, favoring the top view, inclusive of the cut sections of the said lower closure component of the said two-component safety closure system, and basically functionally corresponding to the preferred embodiment in FIG. 1 of the present invention, and wherein a disposable containment sac is optimally in place within the internal containment of the said lower closure component.

FIG. 3 is the top view of the same preferred embodiment of the present invention showing specifically the corresponding top views of the other structural elements attached thereto the said upper closure component as in FIG. 1.

FIG. 4 is the side elevational view with a cut-away view exposing in an inside view manner the internal structural elements of the said downwardly extending structure connecting from the said electric motor, and also showing the said pair of attached equal-length chains anchored firmly to the said downwardly extending structure of the said lower portion of the said electric motor extension structure, and also exposing as well the other structural elements attached to the said upper closure component of the same preferred embodiment as in FIGS. 1 and 3.

FIG. 5 is the perspective side elevational view, favoring the top view, inclusive of a cut-away view exposing some internal structural elements attached thereto the said upper closure component of the same preferred embodiment of the present invention, and, also showing a burned-out fluorescent lamp in a fully inserted vertical position within said cylindrical guide tube.

FIG. 6 is basically the same view as of FIG. 5, except that the said equal-length chains are in the fully swinging and grinding and crushing activities that cause the impacting and grinding and crushing of the lowermost portions of the inserted burned-out fluorescent lamp.

FIG. 7 is basically the same view as of FIGS. 5 and 6, with the exception that, instead of showing the swinging equal-length chains, a flat, blade-like, yet blunt grinder and crusher means is doing the impacting and grinding and crushing of the said lowermost portion of the said inserted burned-out fluorescent lamp.

FIG. 8 shows in details the cleaning mechanism used within the said transparent see-through means of the said upper closure component of the device.

FIG. 9 shows the side elevational view, favoring the top view of the said upper portion of the said cylindrical guide tube, and exposing the spring-like self-sealing valve mechanism made of preferably rubberized material.

FIG. 10 shows one type of locking mechanism of the said device that locks and unlocks the said upper closure component to and from the said lower closure component of the said two-component safety closure system of FIGS. 1 and 2.

FIG. 11 is the composite side and top elevational view of said device in closed operation.

### DETAILED EXPLANATIONS OF THE ILLUSTRATIVE DRAWINGS

In the drawings, I refer to each identical parts with the same functions with identical numerical representations. Related parts with basically closely related functions are identified with the same numeral, but different alphabetic suffixes or with the same alphabet, but different numerical representation.

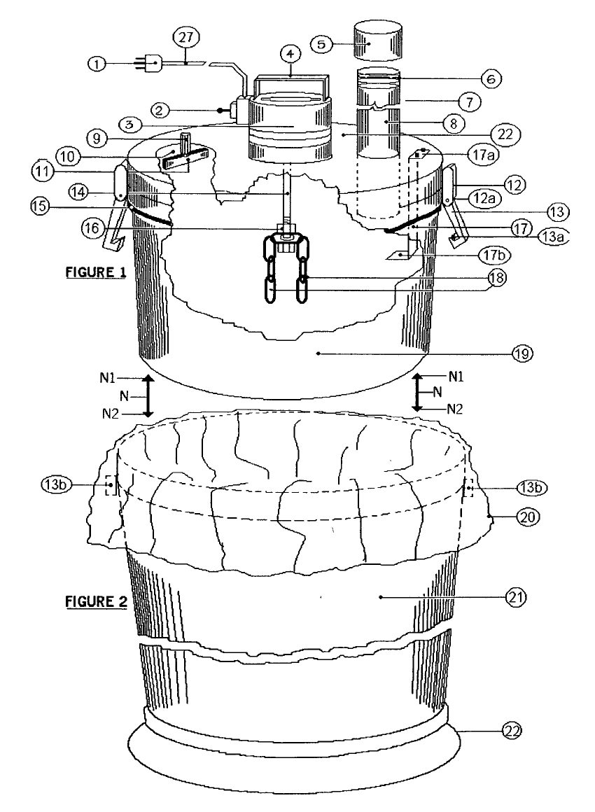

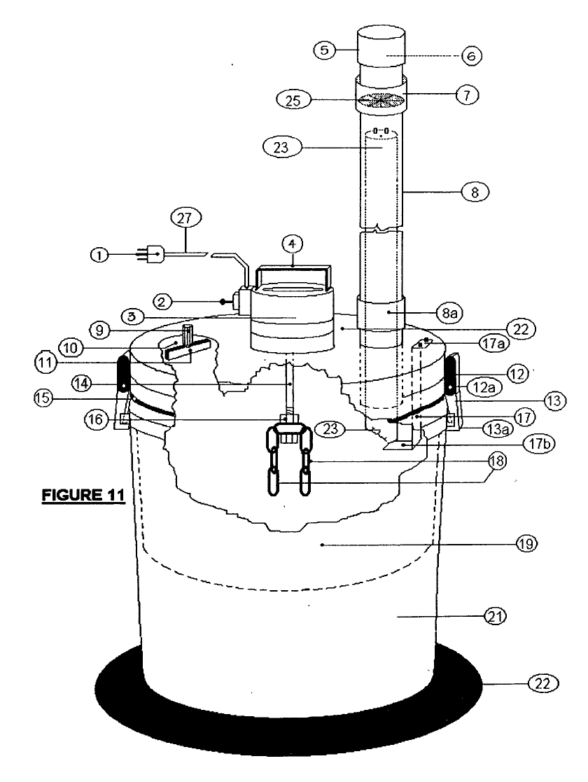

Basically, aside from the containment sac, there are two main large components of the device, and they comprise of the said upper closure component 19, and the said lower closure component 21 as illustrated primarily in FIGS. 1 and 2. These said two main large components, together, when engaged (FIG. 11), is called the said two-component safety closure system. In FIGS. 1 and 2, the said two-component safety closure system is shown to be in a disengaged position. The double-arrow N indicates the directions of disengagement as in N1, and engagement as in N2. The containment means is designated as 20. The said upper closure component 19 is cylindrical, hollow and baseless. It can be optimally fitted into the inner wall and flat base of the said lower closure component 21. Placed in-between the internal wall of the said lower closure component 21 and the external wall of the said upper closure component is the said containment means. The said baseless upper closure component allows direct emptying of the debris and poisonous materials of the crushed burned out fluorescent lamps into 20, thereby filling said containment means 20, which may be made of non-porous and leak-proof plastic or paper material or a combination of the two materials. In FIGS. 6 and 7, the said debris and scattering poisonous materials are seen dropping through the baseless upper closure component, only for illustration purposes to show that emptying of said debris and poisonous materials are directly led out of it from its bottom, but, in actual practice, the said debris and poisonous materials of burned out fluorescent lamps are trapped safely into said containment means shown in FIG. 11 when the said two-component safety closure system of the said device is in complete leak-proof engagement.

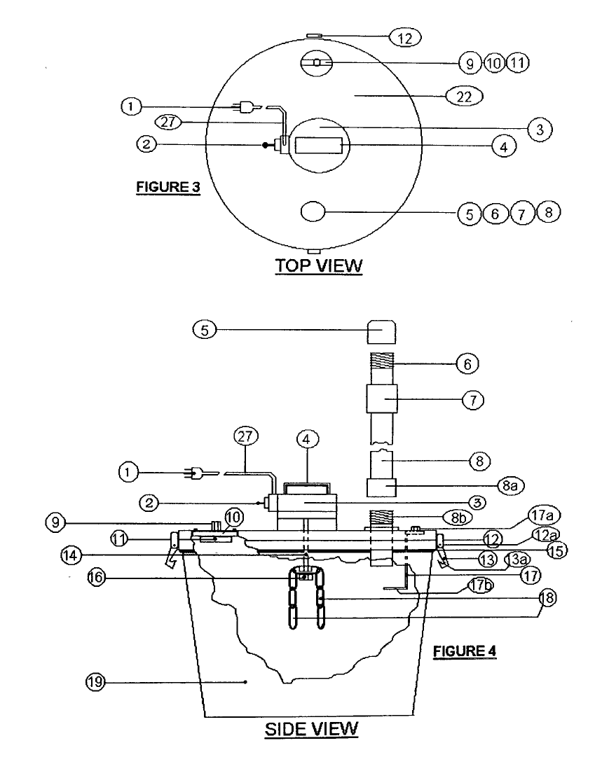

Within the roof 22 of the said upper closure component 19, shown mostly in FIGS. 1, 3, 4,5,6 and 7 are the following structural elements: the electric motor 3, the guide tube 8, the firmly attached portion of locking means which is designated as 12, and, 12a, which is the hinged portion of the locking means 12, and 13 which is the moveable locking arm that extends to form 13a designated as the locking jaw portion of the locking mechanism, and, which can be attached to and from 13b (in FIG. 2) which is attached to the said lower closure component 21, the said see-through transparent window means indicated as 10, the cleaner rotator means as 9, and the internal cleaner wiper as 11 (more clearly illustrated in FIG. 8).

Attached to the upper sector of the said electric motor 3 is handle 4, and, at the side of electric motor 3 is attached the electric switch 2 which is attached to electric plug 1 via electric cable 27.

Below the said electric motor 3 is a said rigid lower structural extension 14 which penetrates the said roof 22, and internally extends downwards to provide at its lowermost end an attachment means 16 onto which are rigidly anchored the equal-length chains 18 made preferably of hard metal or plastic materials.

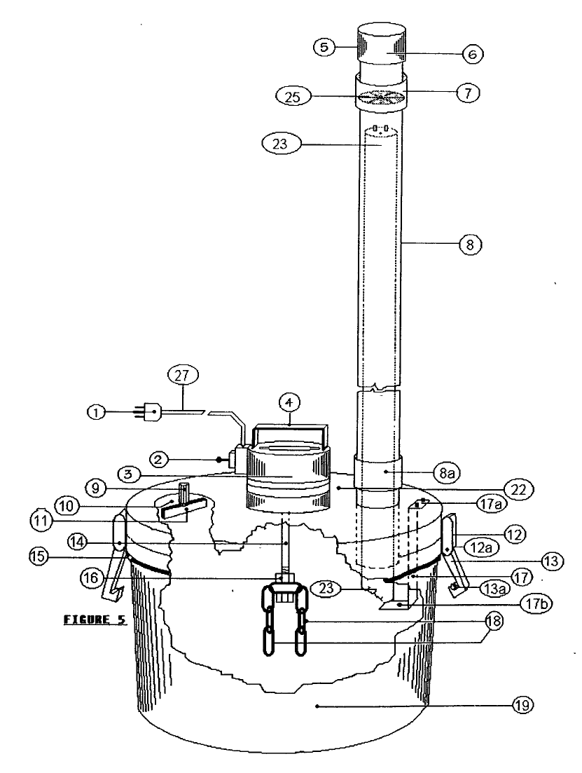

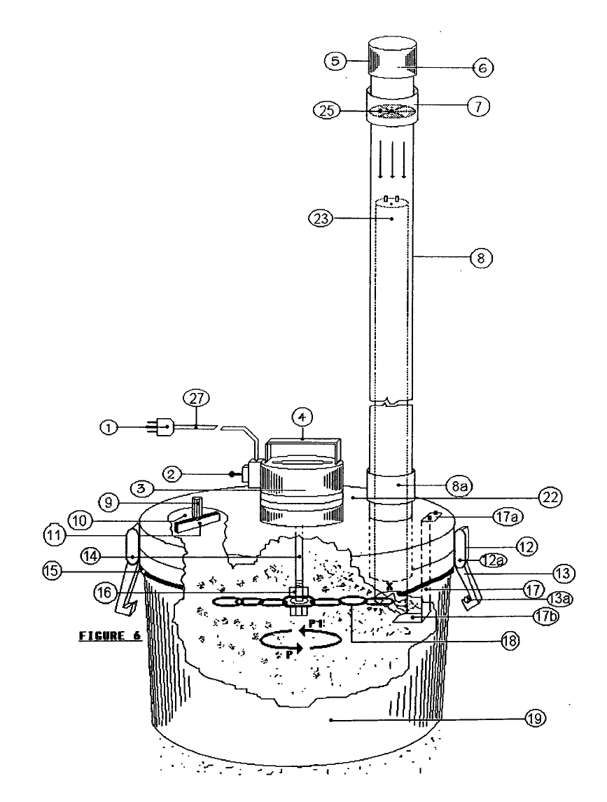

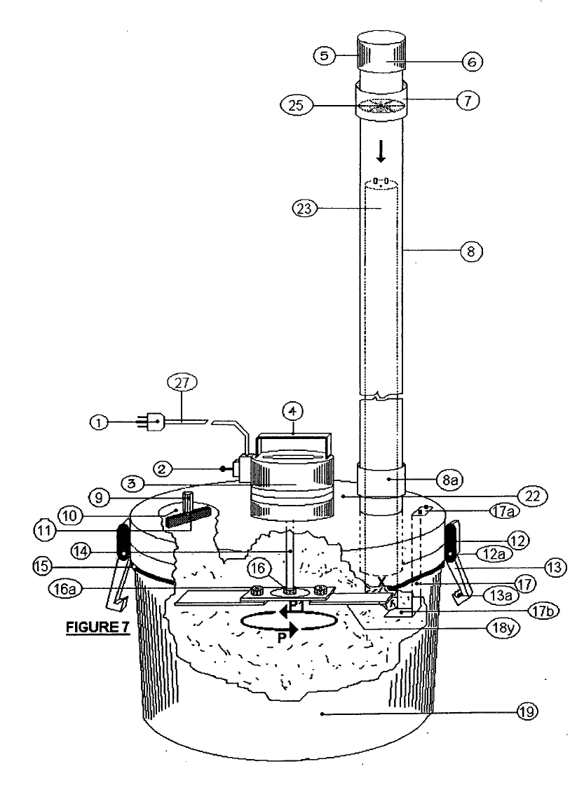

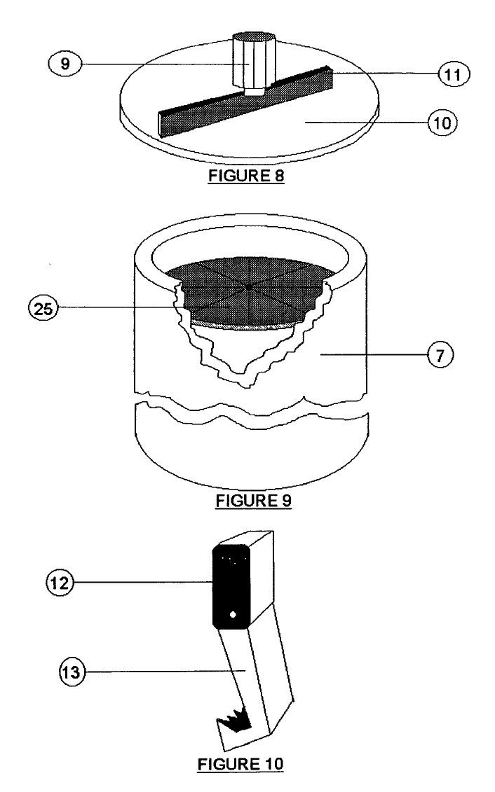

The cap 5 is at the uppermost section of said guide tube 8, and, can be attached by screwing means to threads 6. 8a is the larger-diameter tubular form that can attach by screwing means to thread 8b shown in FIG. 4 of the said guide tube 8.

In FIGS. 1, 4, 5 and 7, there is shown the said limiting structure 17 which has a rigid attachment 17a located at the said roof 22 of the said upper closure component 19, and, said limiting structure 17 has an inwardly directed horizontal structural extension 17b; said 17, 17a and 17b structures are situated parallel and in close optimal proximity, and generally 17 is in a perpendicular alignment with said guide tube 8 which extends firmly through the said roof 22, but only up to point X which is higher than the uppermost possible swing of said equal-length chains 18 in FIGS. 1, 4, 5 and 6, and also higher than the horizontal rotational swing of 18y shown in FIG. 7. The said structural extension 17b limits the downward descent of the lowermost portion of the inserted burned-out fluorescent lamp 23 shown in FIGS. 6 and 7.

In FIGS. 6 and 7, counter-clockwise arrows p and p1 indicate the hi-speed rotation of 18 and 18y.

In FIG. 8, the said hand-controllable rotator 9 directly attaches to 11 which is the said leak-proof plastic or glass material.

In FIG. 9, the upper portion of said guide tube 10 is clearly shown, and within its internal section is attached in a horizontal planar arrangement the said leak-proof rubberized valve 25, through which the burned-out fluorescent lamp is inserted to descend internally.

cleaner means that internally wipes clean the said see-through window 10 which is made of rigid

In FIG. 10, the locking mechanism is shown to have the firm attachment portion 12, and 12a which is the hinged portion, and 13 which is the moveable locking arm, and 13a which is the locking jaw extension.

In FIG. 11, most elements comprising said device are seen and in full closed operation.

Process of Operations

Step 1—Unlock and remove the said upper closure component 19 by first unhinging the said pair of locking arms means 13 from the engagements of the said locking jaws 13a from their attachment to the said firm locking hooks 13b found at the opposite sides of the said lower closure component 21.

Step 2—Lift the whole said upper closure component upwards in the direction of N1 of double arrow N and clear away from the said lower closure component 21. Then, place it to rest in an area within the immediate reach of the handler.

Step 3—Put a large enough strong non-porous and leak-proof plastic or paper containment sac 20, making sure that most of the inside chamber or interior of the said lower closure component is occupied by the said containment sac, and that the outer sections of the said containment sac are outwardly spread out of the whole rim of the said lower closure component.

Step 4—Place and fit the said lower closure component 19 into the internal sections of the said lower closure component 21 in the direction of arrow N2 of said double arrow N, illustrated in FIGS. 1 and 2, and seeing to it that the circumferential edges of 15 of the said upper closure component is fully resting upon the uppermost circumferential rim of the said lower closure component with portions of the said containment sac being sandwiched there-between the said upper closure component and the said lower closure component.

Step 5—Be sure to attach the said locking jaws 13a of the said upper closure component to 13b of the said lower closure component, so that the said two components are firmly engaged in a leak-proof manner.

Step 6—Plug the electric plug 1 into an active electrical socket with enough voltage.

Step 7—Insert the burned out fluorescent lamp 23 steadily into the internal section of the said guide tube 8 through the said rubberized leak-proof valve 25.

Step 8—Switch the electrical switch 2 to the “On” position in order to activate the said electric motor to cause its said lower structural extension to rotate at hi-speed. This will cause the hi-speed swinging of the said attached equal-length chains 18 (FIG. 6) or the said attached blade-like grinder 18y (FIG. 7) in the direction from P to P1 to P to P1 continuously on and on, thus causing the impacting and grinding and crushing of the lowermost sequence of segments of the being inserted or being internally fed burned out fluorescent lamp. The impacted debris including the poisonous materials contained inside the said burned out fluorescent lamp will continuously be collected inside the said containment sac 20 placed inside the said lower closure component (when both the said upper closure component 19 and the said lower closure component 21 are attached together to form a leak-proof two-component safety closure system as in FIG. 11) until all of the segments of the said being internally fed burned out fluorescent lamp is fully grinded.

Step 9—Switch off the electrical power by switching the said electrical switch to the “Off” position.

Step 10—After sufficient waiting time, allowing the debris and poisonous materials of the said fluorescent lamps to settle within the said containment sac 20, it is possible to disengage now the attachment of the said upper closure component from the said lower closure component by unhooking the said pair of locking jaws 13a from 13b.

However, if more burned out fluorescent lamps are still to be fed into the said engaged two-component closure system, the process can be repeated on and on until the said containment sac is optimally full, before disengaging the said two component closure system.

Step 11—Once the said containment sac is full as can be seen and checked through the see-through window 10, the said upper closure component 19 can now be disengaged from its attachment from the lower closure component 21.

It is of great importance to note that, though the present invention has been described and illustrated in the drawings with this preferred embodiment, the descriptions and drawings do not limit the scope of the present invention. Other alternative designs and modifications within the spirit and scope of the present invention may be developed as long as they are within the parameters and spirit of the enumerated claims of the said present inventor, which are readable, recitable and claimed as follows:

1. I, the original inventor and designer of the said present invention officially claim the following independent and dependent claims:
A device comprising of
a) an upper closure component, having an electric motor attached thereto, and having a guide tube means capable of accommodating and guiding the inserted burned out fluorescent lamp interiorly into it, and having impacting and grinding and crushing means to turn said burned out fluorescent lamp into debris, and including limiting means of controlling the internal insertion of said burned out fluorescent lamp; said electric motor having structural connection to said impacting and grinding and crushing means, and including a transparent see-through means and cleaning means to allow easy check up from the outside pertaining to the interior containment as well as the impacting and grinding and crushing progress or status of said device, and including locking and unlocking means—all of which are coordinating and engaging in functionality with:
b) a lower closure component, having optimal and correspondingly shaped containment space to accommodate a substantially large enough non-porous strong plastic or paper sac-conforming containment material placed there-between the internal wall of said lower closure component, and the external wall of the correspondingly and optimally shaped major lower portion of said upper closure component while in the operational engaged containment and impacting and grinding and crushing phase of said device; said lower closure component equipped with a structural means attached there-around its base as an easy foot-controllable detaching means to facilitate the disengagement of said upper closure component from the said lower closure component; said lower closure component having a corresponding locking means to engage in a coordinating manner with the said locking counterpart attached to the said upper closure component.

2. A device according to claim 1, wherein the said upper closure component is equipped with an electric motor mounted centrally and firmly on top of the roof of said upper closure component.

3. A device according to claim 1 wherein the guide tube means is cylindrical and of sufficient length and of optimal diameter to accommodate the insertion of straight burned out fluorescent lamp one at a time, and, wherein the said guide tube is situated off-centered and attached firmly at right angle with the roof of said upper closure component, and wherein said guide tube's lowermost section is not within impacting reach by the said crushing and grinding and impacting means.

4. A device according to claim 1 wherein the said mounted electric motor has a lower structural extension that optimally and securely attaches the rotatable crushing and impacting and grinding means.

5. A device according to claim 1 wherein the roof of the said upper closure component is equipped with a see-through leak-proof window that is situated off-centered, and having externally rotatable swinging cleaning means to allow the maintenance of clear transparency of the said see-through window.

6. A device according to claim 1, wherein the said grinding and impacting and crushing means is made of equal-length chains or horizontally attached blade-like structural configuration of preferably hard metal or hard plastic material or the combination of the two, and wherein the rotating reach of the said equal-length chains or horizontally attached blade-like structural configuration are both optimally measured so as to effect the effective impacting and crushing and grinding of the said being inserted or being fed lowermost segments of burned out straight fluorescent lamp only, but not the other adjacent structures that are not meant to be impacted and crushed and grinded.

7. A device according to claim 1 wherein the locking mechanism that attaches and detaches the said upper closure component to and from the said lower closure component is paired and equidistantly positioned in a firm way.

8. A device according to claim 1, wherein the said guide tube means is equipped with a leak-proof rubberized valve internally and horizontally positioned within it.

9. A device according to claim 1, wherein the said upper closure component is equipped with a firmly attached structural limiter that prevents the full descent of the internally fed straight burned out fluorescent lamp, in such a close perpendicular fashion that allows the full impacting and crushing and grinding of the said burned out fluorescent lamp without hitting the structure of the said structural limiter.
